(19) United States
(12) Patent Application Publication
(10) Pub. No.: US 2006/0103544 A1
(43) Pub. Date: May 18, 2006

(54) Vehicle light

(76) Inventors: Bernd Merz, Kohlberg (DE); Volker Sandtrock, Kusterdingen (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/264,277

(22) Filed: Nov. 1, 2005

(30) Foreign Application Priority Data
Nov. 3, 2004 (DE) 10 2004 053 089.0

(51) Int. Cl. G09F 9/33; B60Q 1/00; B60Q 1/22; B60Q 1/26; G08B 5/00

(52) U.S. Cl. 340/815.45; 340/815.42; 340/468; 340/463; 340/461

(57) ABSTRACT

The light source of a vehicle light is formed by several COB-LED chips which are disposed on a common printed circuit board and are electrically connected in series.

This application claims priority under 35 U.S.C. §119(a) to German Patent Application No. 10 2004 053 089.0, filed Nov. 3, 2004, the entire contents of which are hereby incorporated by reference.

### BACKGROUND OF THE INVENTION

The present invention relates to a motor vehicle light, in particular, an interior light, an indicator light or a brake light comprising at least one light source.

With vehicle lights with rod-shaped optical fiber, it is difficult to effectively couple the light of many individual LEDs into the rod. To nevertheless provide a sufficient amount of light, “high-performance LEDs” must be used. These LEDs are operated with currents of several hundred milliamperes. The voltage at the LED is thereby in a range between 2 and 4 V. The nominal voltage of vehicles is, however, 13.5 V. To limit the LED current, a protective resistor is used which converts excess energy into heat. If a protective resistor is used also for high-performance LEDs, this energy will become extremely large due to the high current: with U=13.5V, U_{LED}=2.5V it follows U_{R}=U−U_{LED}=13.5V−2.5V=11V. Assuming an LED current of I_{LED}=0.5 A, the power loss at the resistor is P_{R}=U_{R}*I_{LED}=11V*0.5 A=5.5 W. This produces a power dissipation of more than 8 W for conventional maximum voltages of 16 V in the automotive industry. The required high ambient temperature of e.g. 85° C. must also be taken into consideration. This high power dissipation must be converted into heat via one or more resistors which become extremely hot which may cause e.g. melting of the plastic housing. For this reason, temperature-resistant materials must be used. Accommodation of the resistors in the housing requires e.g. a large printed circuit board which also increases the system costs. The LEDs react sensitively to high temperatures and darken correspondingly. For this reason, one must prevent transfer of heat from the protective resistors to the LEDs which increases the construction expense. Additionally, the electric efficiency of the vehicle light is extremely deteriorated since only approximately 1 W is converted into light on the LED and approximately 5 W is converted into heat on the resistor. This increased energy consumption increases again the fuel consumption of the vehicle.

A clocked control with e.g. a DC/DC converter may alternatively be used instead of a protective resistor. The efficiency is thereby considerably improved. These modules, however, require an additional printed circuit board and are very expensive. Moreover, electric disturbing pulses may occur which may cause problems in the vehicle.

In contrast thereto, it is the underlying object of the present invention to eliminate the above-described disadvantages of a vehicle light of the above-mentioned type.

### SUMMARY OF THE INVENTION

This object is achieved in accordance with the invention in that the or each light source is formed by several COB-LED chips which are disposed on a common printed circuit board and are electrically connected in series.

In the conventional chip-on-board technology (COB), the LED chip is glued directly onto a suitable printed circuit board and is electrically connected to the printed circuit board via bond wires. To obtain good heat dissipation, the chip is preferably mounted to an aluminium (Al) printed circuit board. To improve the optical efficiency, a truncated reflector may be milled into the Al printed circuit board. The chip is disposed therein and then protected with a silicone cast.

To eliminate the above-mentioned disadvantages, in accordance with the invention, several COB-LED chips are disposed in a reflector of this type. Several chips generate light in this case, for which reason, smaller and less expensive chips can be used. These LED chips are connected via the bond wires in such a manner that an electric series connection is produced.

From an optical point of view, this is one single light source, the light of which is fed e.g. into an optical fiber. From an electrical point of view, one obtains a series connection of several LEDs. This considerably reduces the power loss at the protective resistor. With four COB-LEDs having one LED each, the voltage per LED is also in this case U_{LED}=2.5V and U=−3.5V results in U_{R}=U−4*U_{LED}=13.5V−4*2.5V=3.5V. The LED current can be reduced to ¼, i.e. to I_{LED}=0.125 A obtaining the same luminance, due to the four COB-LEDs. This produces a power dissipation of P_{R}=U_{R}*I_{LED}=3.5 V*0.125 A=0.44 W at the protective resistor. The power dissipation is therefore only approximately 8% of the power dissipation of a high-performance LED. This amount of approximately 0.5 W can be easily converted into heat using a resistor. However, it must be taken into consideration that the optical efficiency is slightly reduced due to the larger number of chips, since the individual chips shade each other. This effect can be reduced, however, through suitable arrangement of the chips in the reflector. The power loss in the LED is the same in both cases, namely for a high-performance LED 2.5 V*0.5 A=1.25 W and for four COB-LEDs 4*2.5*0.125=1.25 W.

Further advantages can be obtained through the possibility of adapting the radiation characteristic of the COB-LEDs to the requirements by the shape of the reflector in the Al printed circuit board and by the shape and size of the silicone cast. One is therefore not limited to the properties predetermined by the LED producers.

The advantages of the COB technology may always be utilized when a smaller number of LEDs is required.

The inventive vehicle light advantageously comprises an optical fiber into which the light from the light source is coupled and at an exit surface of which the light is decoupled.

Further advantages of the invention can be extracted from the description and the drawing. The features mentioned above and below may be used individually or collectively in arbitrary combination. The embodiments shown and described are not to be understood as exhaustive enumeration but have exemplary character for describing the invention.

### BRIEF DESCRIPTION OF THE INVENTION

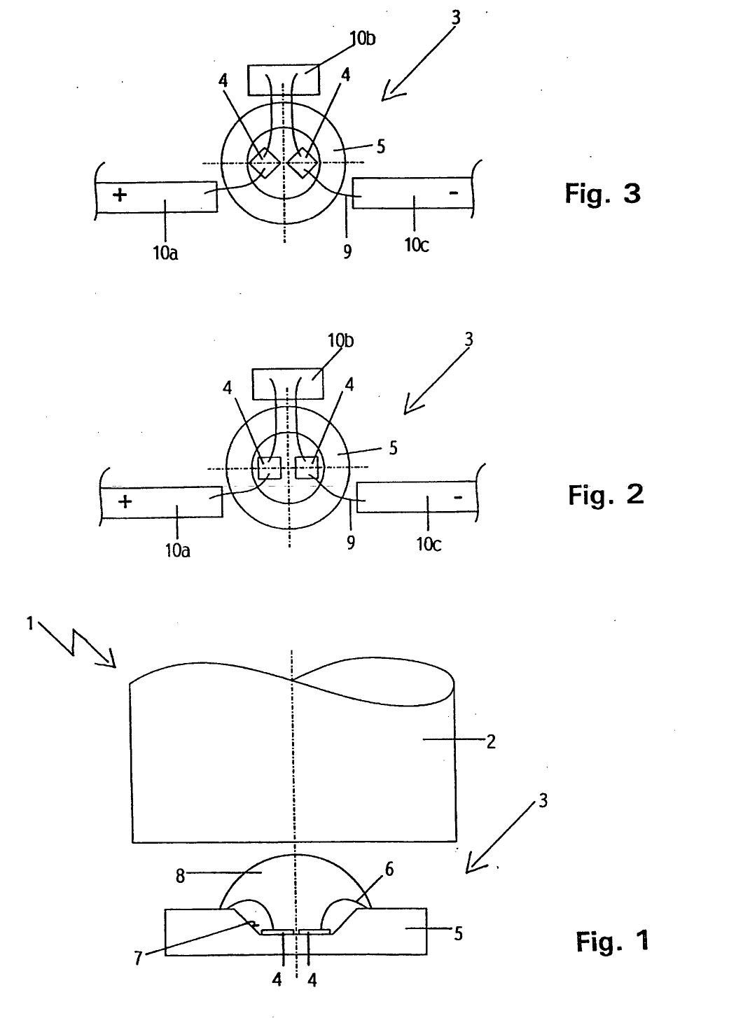

FIG. 1 shows the inventive vehicle light comprising a light source which is disposed at the end face of an optical fiber in front thereof;

FIG. 2 shows a first embodiment of the light source of FIG. 1; and

FIG. 3 shows a second embodiment of the light source of FIG. 1.

### DESCRIPTION OF THE PREFERRED EMBODIMENT

The vehicle light 1 of FIG. 1 is a so-called raised brake light which is disposed as third brake light centrally in the rear or rear window of a vehicle. The vehicle light 1 comprises an optical fiber 2 into an end face of which the light from a light source 3 is coupled and at an exit surface (not shown) of the cladding of which the light is decoupled along its length.

The light source 3 comprises two square COB-LED chips 4 each having one LED which is directly mounted to an aluminium (Al) printed circuit board 5 and is electrically connected to the printed circuit board 5 via bond wires 6. To improve the optical efficiency, a truncated reflector 7 is milled into the printed board 5. The two COB-LED ships 4 are disposed on the bottom surface of the reflector 7 and are protected by a silicone cast 8.

FIG. 2 shows a first embodiment of the light source 3 of FIG. 1, wherein the two COB-LED chips 4 are disposed relative to each other such that their edges facing one another are parallel. The COB-LED ships 4 are connected to copper (Cu) strip conductors 10 of the printed circuit board via bond wires 9, and are electrically connected in series, wherein the strip conductor 10a is connected to +and the strip conductor 10c is connected to—and the strip conductor 10b connects the two COB-LED chips 4 to each other. The light beams from the LED of one COB-LED chip 4 which are reflected to the reflector center are, however, partially absorbed by the respective other COB-LED chip 4.

FIG. 3 shows a second embodiment of the light source 3 of FIG. 1, wherein the corners of two COB-LED chips 4 face each other, i.e. are both rotated through 45° with respect to FIG. 2. Due to this orientation, the mutual shading of the LEDs of the COB-LED chips 4 is considerably reduced, thereby increasing the luminance by approximately 20% compared to the embodiment of FIG. 2.

We claim:

1. Vehicle light, in particular, interior light, indicator light or brake light, comprising at least one light source, the light source being formed by several COB-LED chips disposed on a common printed circuit board and electrically connected in series.

2. Vehicle light according to claim 1, wherein the printed circuit board comprises a truncated reflector on a bottom surface, the COB-LED chips being disposed on the bottom surface.

3. Vehicle light according to claim 1, wherein the COB-LED chips are coated with a silicone layer.

4. Vehicle light according to claim 1, wherein the COB-LED chips are disposed relative to each other in such a manner that mutual shading thereof is reduced.

5. Vehicle light according to claim 4, wherein two COB-LED chips are disposed opposite to each other with edges extending parallel to each other.

6. Vehicle light according to claim 4, wherein two COB-LED chips are disposed relative to each other with a corner of one chip facing a corner of another chip.

7. Vehicle light according to claim 1, further comprising an optical fiber disposed for receiving light from the light source, the light being decoupled from the optical fiber through an exit surface.

8. Vehicle light according to claim 2, wherein the COB-LED chips are coated with a silicone layer, wherein the COB-LED chips are disposed relative to each other in such a manner that mutual shading thereof is reduced and wherein an optical fiber is disposed for receiving light from the light source, the light being decoupled from the optic fiber through an exit surface.

9. Vehicle light according to claim 8, wherein two COB-LED chips are disposed opposite to each other with their edges extending parallel to each other.

10. Vehicle light according to claim 8, wherein two COB-LED chips are disposed relative to each other with a corner of one chip facing a corner of another chip.
